(19) United States
(12) Patent Application Publication
(10) Pub. No.: US 2005/0011544 A1
(43) Pub. Date: Jan. 20, 2005

(54) Device for controlling the washing process for items to be washed in a dishwasher

(75) Inventors: Michael Rosenbauer, Reimlingen (DE); Bernd Schessl, Dillingen (DE); Helmut Jerg, Giengen (DE)

Correspondence Address: JOHN T. WINBURN, 100 BOSCH BOULEVARD, NEW BERN, NC, 28562, US

(73) Assignee: BSH Bosch und Siemens Hausgerate GmbH, Munich (DE)

(21) Appl. No.: 10/872,599

(22) Filed: Jun. 21, 2004

(30) Foreign Application Priority Data
Nov. 15, 2002 (WO) PCT/EP02/12833
Dec. 29, 2001 (DE) 101 62 505.7

(51) Int. Cl. B08B 3/02

(52) U.S. Cl. 134/57 D; 134/172; 134/178; 134/58 D

(57) ABSTRACT

A device for cleaning items in a dish rack in a dishwasher, including at least two individually controlled spray devices or spray arms. The cleaning device controls the spray devices to provide fluid as desired to specific areas of the dish rack to provide optimal cleaning of the items arranged in the dish rack.

The present invention relates to a device for cleaning items to be washed in a dishwasher with at least one dish rack.

DE-OS 27 02 644 discloses a dish rack for dishwashers, which in the storage region provides tubes, which are in each case fitted with openings to supply the directly superjacent items to be washed with a rinse fluid. During the wash cycle rinse fluid enters through all configured openings into the tubes of the dish rack configured as supply line. Owing to the narrow supply tubes there is a clear drop in pressure as far as the point farthest from the influx of the tubes.

Because of this the wash or spray capacity is not configured equally in all areas of the dish rack, so that in areas, which are the farthest from the influx, the spray jet strikes the items to be washed at a diminished speed.

This disadvantage is all the more serious if particularly stubborn items to be washed are stacked in these areas of the dish rack remote from the influx, resulting in a varying wash quality in a dish rack.

The object of the present invention is therefore to provide a device, which enables items to be washed stacked in a dish rack with varying contamination to be cleaned optimally according to the degree of contamination.

This task is solved by the inventive device for cleaning items to be washed in a dishwasher with the characteristics according to claim 1. Advantageous further developments of the present invention are characterised in the independent claims.

With the inventive device for cleaning items to be washed in a dishwasher with at least one dish rack at least two spraying devices for specific areas are assigned at least to one dish rack according to the present invention, and the device has a control mechanism for individual control of the at least two spraying devices of a dish rack during cleaning.

Preferably the spraying devices are arranged under the dish rack and in each case comprising rotary spray arms.

By way of advantage the at least two spraying devices are configured in sections in individual areas, preferably quadrants, which are in each case configured to be blocked off from the other areas by blocking means, so that the control mechanism for controlling specific areas can control the rinse fluid precisely in individual areas, by means of which those items to be washed with stubborn contamination can be supplied more intensively with rinse liquid, whereas other areas, for example stacked only with glasses, receive less intensive spray treatment.

In a preferred embodiment of the present invention rotary spray arms, whereby a rotating or rotatable spray arm is arranged in each specific area, form the spraying devices. The areas are configured preferably as quadrants.

The selectable areas are effectively configured separately from one another by a blocking means.

The advantage of the inventive device is that consumption values, in particular the water and power consumption values are optimised for the respective wash cycles, i.e. the water consumption or the power consumption drops on average.

The inventive device can be utilised both in domestic and commercial dishwashers, as well as in these respective devices both in the upper and the lower rack, and in each case are used separately in only one dish rack.

The inventive device will now be explained in greater detail hereinbelow in terms of an embodiment by means of diagrams, in which:

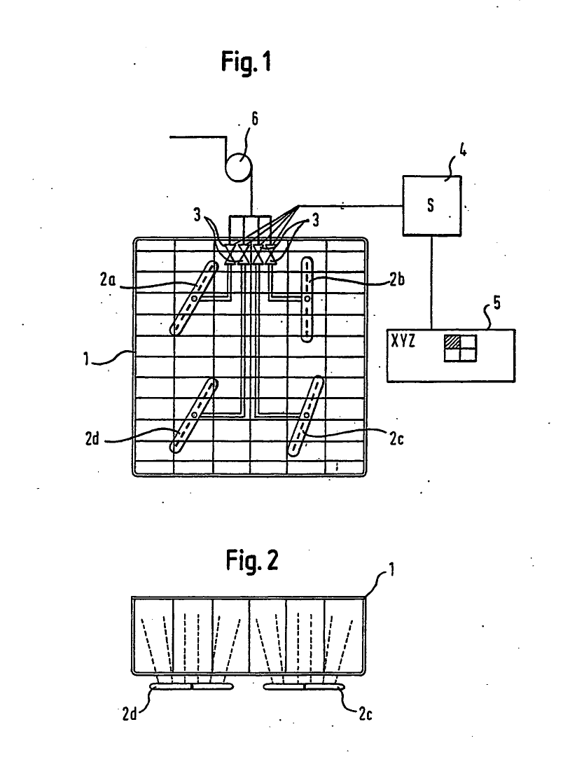

FIG. 1 is a schematic plan view of the inventive device, and

FIG. 2 is a schematic side elevation of the inventive device.

In the inventive device according to FIG. 1 a dish rack 1 with spraying devices 2a-2d configured as rotatable spray arms is illustrated schematically, whereby the spray arms 2a-2d terminate separately in blocking means 3 in each case. The spray arms 2a-2d are arranged under the dish rack 1. The supply area to the blocking means 3 is funnelled in the direction of the circulating pump 6, thus configuring a central area, from which the respective influx areas supply the spray arms 2a-2d above the blocking means 3. In the illustrated embodiment these blocking means 3 are configured as a magnetic valve. The areas are configured in the illustrated embodiment as quadrants, whereby the fulcrum of a spray arm 2a-2d is arranged in the centre of each quadrant. Each of the individual specific areas is configured so as to be blocked off from the other areas by blocking means 3.

The blocking means 3 are controlled by the control mechanism 4, which is in turn connected to the control mechanism (not shown or integrated therein) of the dishwasher, whereby the respective control rhythms, which control the wash cycles, are backed up in a control program. To drive the respective spray arms 2a-2d as they are selected, the control mechanism 4 is connected to an operating element 5, which has a schematic illustration of the spray device areas 2a-2d and advantageously displays the areas selected in each case via lighting elements. In the illustrated embodiment with selected division into quadrants, i.e. division of a substantially square configured dish rack 1 into four equal-sized surfaces, a keypad with four keys is provided an a console of the operational control 5, which represent the respective quadrants, provided for a more intensive wash cycle.

In selecting the respective quadrants or zones the user can, as long as the selection is done manually, select an area to be washed more intensively by actuating the corresponding keys. The method is to be selected optionally, or provided in specific wash cycles.

In FIG. 2 the inventive device is illustrated in a schematic side elevation, with a dish rack 1 and two spray arms 2c and 2d. According to the illustrated selection option the respective spray arms 2a to 2d are driven individually, whereby each spray arm has a delimited area, which can be supplied reliably with rinse fluid.

In addition to selection of the respective areas it is also possible to alter the spray jet intensity, where for example the speed control of the circulating pump motor is changed, and thus the exit rate of the spray jets can correspondingly be matched to the respective requirements. In addition to the option of the user making the area selection manually via the console, it is also possible according to the present invention to recognise those items to be washed with particularly stubborn soiling by means of sensors housed in the wash container, for example via a camera, and to manually select those respective areas or have them selected automatically, which are to undergo more intensive cleaning during the wash cycle.

Due to the inventive device items to be washed with stubborn contamination can be sprayed more intensively with rinse fluid, whereas other areas, for example those stacked only with glasses, undergo less intensive spray treatment, where a device is provided, which enables items to be washed stacked in a dish rack 1 with varying contamination to be cleaned optimally according to the degree of contamination.

A further advantageous result of the inventive device is that the consumption values, in particular the water and power consumption values, are optimised for the respective wash cycles, i.e. the water consumption or the power consumption drops on average.

1-7. (canceled)

8. A device for cleaning items to be washed in a dishwasher with at least one dish rack for the items, comprising:
two separate spraying devices for supplying wash fluids, each said spraying device covering at least one separate area of the dish rack; and
a control mechanism for individually driving each of said two separate spraying devices during a washing operation.

9. The device according to claim 8, including said two separate spraying devices are arranged under said dish rack.

10. The device according to claim 8, including each of said two separate spraying devices is a rotary spray arm.

11. The device according to claim 8, including said separate areas of the dish rack are configured as quadrants of said dish rack.

12. The device according to claim 11, including each of said separate areas of said dish rack is configured to be closed off from the other ones of said separate areas by blocking means.

13. The device according to claim 12, including said blocking means include valves, which are driven by said control mechanism.

14. The device according to claim 13, including said separate areas of said dish rack are configured as four (4) separate areas, each area driven by a separate valve or valve section to supply the areas individually with fluid during washing.
